(19) United States
(12) Patent Application Publication
(10) Pub. No.: US 2010/0288977 A1
(43) Pub. Date: Nov. 18, 2010

(54) Corrosion protection under influence of corrosive species

(75) Inventors: Mikko Uusitalo, Tampere (FI); Janne Nurminen, (US)

Correspondence Address: HARRINGTON & SMITH, 4 RESEARCH DRIVE, Suite 202, SHELTON, CT, 06484-6212, US

(73) Assignee: Metso Minerals, Inc.

(21) Appl. No.: 12/454,309

(22) Filed: May 15, 2009

(51) Int. Cl. C09K 3/00; B23K 31/02

(52) U.S. Cl. 252/387; 228/101; 228/199

(57) ABSTRACT

A component adapted to an environment exposed to corrosive species such as chlorine, which component has a substrate and a coating on the substrate configured to shield the substrate from erosion and corrosion. The coating is formed and metallurgically bonded to the substrate by nickel vapor depositing and hot isostatic pressing or by surface brazing. The coating is manufactured to form a dense layer consisting of a protective material that substantially reduces corrosion rate under the presence of the corrosive species.

### TECHNICAL FIELD

The present invention generally relates to corrosion protection under influence of corrosive species. The invention relates particularly, though not exclusively, to corrosion protection under influence of corrosive species and high temperature.

### BACKGROUND ART

Various surfaces such as heat transfer surfaces of power generation stations are exposed to corrosion and erosion. In order to protect such surfaces from extensive erosion it is known that protective separate liners are provided to guard exposed surfaces or the surfaces as such are protected against erosion. The protection is typically produced by manufacturing a liner of stainless steel, see e.g. http://uneek.com.au/uploads/PDFs/UneekBoilerShields pdf.

It is also known that separate corrosion shields sometimes become loose or even fall out of place. The replacement of the corrosion shields in boilers is a time consuming operation and also the omission of the shields may expose normally protected components to rapid erosion and corrosion.

It is also known that boiler components are coated with corrosion or erosion-resistant material to increase the life-time of so protected components in harsh conditions. Methods such as thermal spraying, weld overlay coating, laser coating and use of compound tubes are known techniques for providing such coatings. However all these methods have their fallbacks. Thermal spay coatings are thin and the bonding to underlying substrate (i.e. material being protected) is weak. Thermal spray coatings are also porous to certain extend and thus corrosive species may penetrate the coatings. On the other hand, weld overlay coatings expose the substrate material to extensive heat and decrease the mechanical properties of the substrate. Weld overlay coatings also mix with substrate material, and diluted elements such as iron reduce the corrosion resistance of coatings in chlorine-containing environments.

Most of the coatings that are applied to reduce corrosion rate in power plants contain chromium. The basic idea is that chromium oxide layer is formed on top of the coating, and that this layer protects the coating from further deterioration. However, the effect of chromium to promote corrosion resistance of metals in chlorine-containing high temperature environments may yet be insufficient or substantially diminish after a relatively short period of time.

Stainless steel and Ni-based alloys are relatively resistant against corrosion, but as relatively soft materials, they are exposed to erosion. Carbides such as tungsten carbide (WC) and chromium carbides are hard, and these carbides are often added to coatings as erosion protection particles in order to increase hardness and to improve erosion resistance. These carbides are generally not, however, stable under presence of heat and chlorine. In chlorine-containing environments these carbides are attacked by chlorine and thus the use of these carbides as an erosion resistant component of coatings in chlorine-containing high temperature environments should be avoided.

One further problem with coatings that are aimed for corrosion protection is the limited life-time of such coatings. After a given life-time, corrosion and/or erosion penetrates the coatings that are too thin or too porous to protect the substrate with the consequence that the substrate becomes prone to corrosive attack.

Aluminum oxide (Al₂O₃) is considered as a stable material in high temperature chlorine-containing atmospheres. Aluminum may be alloyed with stainless steel so as to form aluminum oxide layer. The problem with the formed Al₂O₃ layer is that such a layer is thin and brittle. Moreover, Al₂O₃ has a constant of thermal expansion that is considerably lower than that of most constructional metal alloys. As a result, continuous Al₂O₃ coatings formed on steel components tend to crack upon heating and cooling cycles, and the protective effect of the coating becomes easily lost.

### SUMMARY

According to a first aspect of the invention there is provided a component adapted to an environment exposed to corrosive species, the component comprising:
a substrate; and
a coating on the substrate configured to shield the substrate from at least one of erosion and corrosion; wherein
the coating is formed by nickel vapor deposition; and
the coating is configured to form a dense layer consisting of a protective material that substantially reduces corrosion rate under presence of the corrosive species.

The coating may further be hot isostatic pressing processed.

According to a second aspect of the invention there is provided a component adapted to an environment exposed to corrosive species, the component comprising:
a substrate; and
a coating on the substrate configured to shield the substrate from at least one of erosion and corrosion; wherein
the coating is metallurgically bonded to the substrate; and
the coating is surface brazed onto the substrate so as to form a dense layer against corroding of the substrate by the corrosive species.

The coating may be surface brazed onto the substrate by using infiltration.

The protective material may be formed by surface brazing erosion protection particles to the substrate

Surface brazing may refer to forming a coating of brazing material.

The protective material may comprise brazing material that is alloyed to have a melting temperature that is substantially lower than the melting temperature of the erosion protection particles. The erosion protection particles may be formed of the metallic or ceramic materials. The erosion protection particles may remain at least partly not molten through the surface brazing.

The brazing material may comprise Ni-based brazing alloys including BNi-1, BNi-1a, BNi-2, BNi-3, BNi-4, BNi-5, BNi-6, BNi-7 according to American Welding Society standards (Specification for Filler Metals for Brazing and Braze Welding); and Cu based surface brazing materials.

The surface brazing may be performed in a temperature range of 950 to 1150 degrees of Celsius.

The protective material may substantially reduce corrosion rate under presence of the corrosive species.

There are numerous embodiments that may be applied to the component of the first and second aspect of the invention.

The substrate may be formed of one or more outer substrates of a structure that is being protected against at least one of corrosion and erosion.

The substantial reducing of corrosion rate may involve reducing corrosion rate to an extent in which savings are obtained by extending maintenance interval and/or by increasing temperature of the components, which savings exceed the cost of producing the coating according to the first aspect.

The erosion protection particles may be formed of a material selected from a group consisting of: ceramic material such as Al₂O₃, SiO₂, ZrO₂, Cr₂O₃, partially stabilized zirconia (PSZ), mixed oxides, metallic materials such as Ni, Co, Cu, Ag, W, Mo, Fe, Cr or their alloys; and substantially inert carbides such as TiC.

The erosion protection particles may comprise less than 5 weight % carbon. Alternatively, the erosion protection particles may comprise less than 2 weight % carbon. Further alternatively, the erosion protection particles may comprise less than 0.2 weight % carbon. Still further alternatively, the erosion protection particles may comprises less than 1 weight % or less than 0.5 weight % of carbides.

The component may be adapted to use in presence of the corrosive species in material temperature of 400 to 600 degree of Celsius.

The dense layer may be configured to prevent or substantially mitigate entry of the corrosive species through the dense layer to the substrate.

The corrosive species may comprise chlorine or chlorine compounds.

The protective material may be substantially inert in the presence of the chlorine or chlorine compounds in gaseous form.

The protective material may be substantially inert in the presence of chlorine compounds in molten form.

The protective material may be substantially inert in the presence of the chlorine compounds in solid form.

The protective material may be substantially inert in the presence of the chlorine or chlorine compounds and oxygen.

The protective material and the substrate may have substantially similar thermal expansion coefficients.

The component may be a replaceable shield for a steam boiler, the replaceable shield being configured to protect against at least one of erosion and corrosion. Alternatively, the component may be a steam boiler component and form or belong to at least a part of one of the following: tubes and attachments; air pre-heaters; economizers; boiler bank; furnace; super heaters; combustion air nozzles; and smelt spouts.

According to a third aspect of the invention there is provided a method for manufacturing a component adapted to an environment exposed to corrosive species, the component comprising:
a substrate; and
a coating on the substrate configured to shield the substrate from erosion and corrosion;
the method comprising:
metallurgically bonding the coating to the substrate by surface brazing; and
forming by the coating a dense layer so as to form a dense layer against corroding of the substrate by the corrosive species.

The erosion protection particles may be coated so as to improve wetting in surface brazing process. The surface brazing process may be a brazing material infiltration process.

The coating of the erosion protection particles may use an electrolytic process, a chemical process, mechanical depositing, physical vapor deposition process, chemical vapor deposition process, nickel vapor deposition process, and any combination thereof.

The protective material may be formed in a process comprising:
placing sheets of brazing material and erosion protection particles against the substrate; and
heating the substrate, brazing material and the erosion protection particles such that the brazing material infiltrates the erosion protection particles and attaches to the substrate.

The protective material may be formed in a process comprising:
mixing brazing material and erosion protection particles to a mixture;
forming a preform of the mixture onto the substrate; and
heating the substrate and the mixture such that the brazing material surface brazes particles in the erosion protection particles powder to each other and to the substrate.

The protective material may be formed in a process comprising:
mixing brazing material and erosion protection particles to a mixture;
spraying the mixture onto the substrate; and
heating the substrate and the mixture such that the brazing material surface brazes particles in the erosion protection particles powder to each other and to the substrate.

The protective material may be formed in a process comprising:
mixing brazing material and erosion protection particles to a mixture;
forming a slurry comprising the mixture and applying the slurry onto the substrate; and
heating the substrate and the mixture such that the brazing material surface brazes particles in the erosion protection particles powder to each other and to the substrate.

The brazing material being mixed with the erosion protection particles may be brazing material powder.

The component may be heat treated after the surface brazing such that mechanical properties of the component are improved. The mechanical properties may involve elongation at failure, ductility, and/or tensile strength.

The method may further comprise forming a dense layer by the protective material to prevent or substantially mitigate entry of gas through the dense layer.

The protective material and the substrate may have substantially common thermal expansion coefficients.

Different aspects and embodiments of the present invention have been illustrated in the foregoing. The above embodiments are used merely to explain selected aspects or steps that may be utilized in implementations of the present invention. Some embodiments may be presented only with reference to certain aspects of the invention. It should be appreciated that corresponding embodiments may apply to other aspects as well.

### BRIEF DESCRIPTION OF THE DRAWINGS

The invention will be described, by way of example only, with reference to the accompanying drawings, in which:

FIG. 1 shows a schematic picture of a component according to an embodiment of the invention;

FIG. 2 shows a schematic picture of a component according to another embodiment of the invention;

FIG. 3 illustrates a process according to an embodiment of the invention for manufacturing a component adapted to an environment exposed to chlorine;

FIG. 4 shows a process according to another embodiment of the invention for forming protective material for a component adapted to an environment exposed to chlorine; and

FIG. 5 shows a process for protecting a component against corrosion and/or erosion under presence of corrosive species and high temperature according to a yet further embodiment of the invention.

### DETAILED DESCRIPTION

In the following description, like numbers denote like elements. Through this document terms comprise and contain are interchangeable open-ended definitions which mean that particular items so defined are present without intention to exclude any other items.

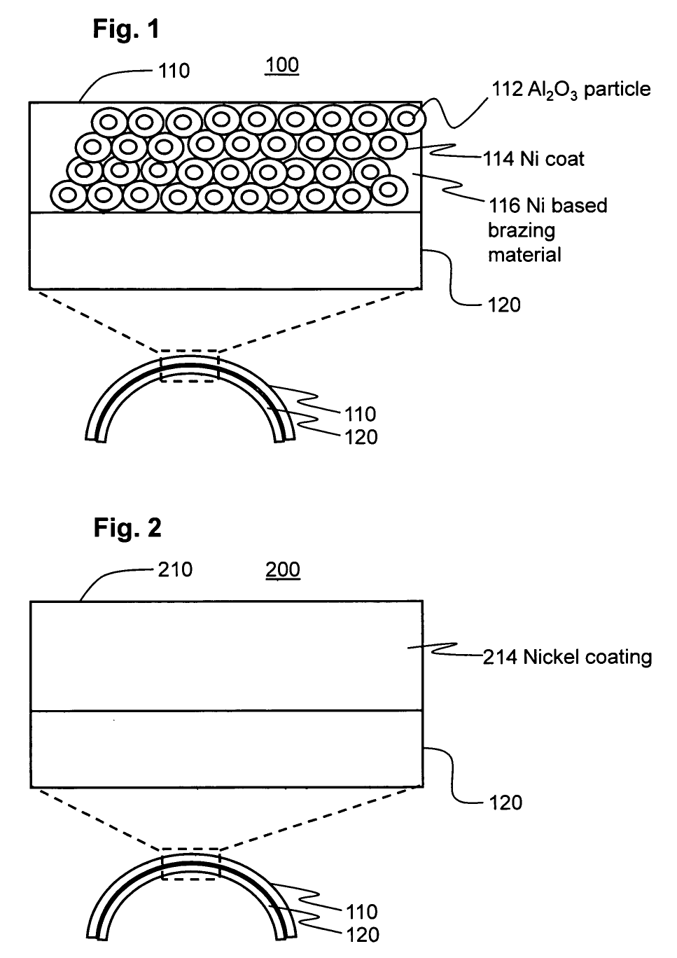

FIG. 1 shows a schematic picture of a component 100 according to an embodiment of the invention. The component in FIG. 1 may be, for instance, a pipe, super heater or replaceable shield element. The component 1 has a substrate 120 that is covered by a coating 110. The coating 110 is provided to prevent or inhibit erosion and/or corrosion of the substrate 120 from outside (i.e. from the side of the coating) in the presence of corrosive species such as chlorine and in high temperatures such as 100° C. to 750° C. or particularly e.g. 400° C. to 600° C. The coating of FIG. 1 comprises erosion protection particles such as substantially inert ceramic particles (e.g. Al₂O₃, SiO₂, ZrO₂, Cr₂O₃), Partially Stabilized Zirconia (PSZ), mixed oxides, inert metallic materials such as Ni, Co, Cu, Ag, W, Mo, Fe, Cr or their alloys; and substantially inert carbides such as TiC. FIG. 1 demonstrates Al₂O₃ particles with nickel coating order to improve wetting of the particles. Thus treated particles have been surface brazed together and to the substrate 120 with Ni-based brazing material such that a metallurgic bond has been formed between the substrate 120 and the coating 110.

FIG. 2 shows a schematic picture of a component 200 according to another embodiment of the invention. In this embodiment, the component 200 comprises a substrate 120 as in FIG. 1, but there are no erosion protection particles. Instead, the substrate 120 has been coated with corrosion and/or erosion resistant metallic coating such as nickel. The coating may be performed, for instance, by using a nickel vapor deposit (NVD) process followed by hot isostatic pressing (HIP).

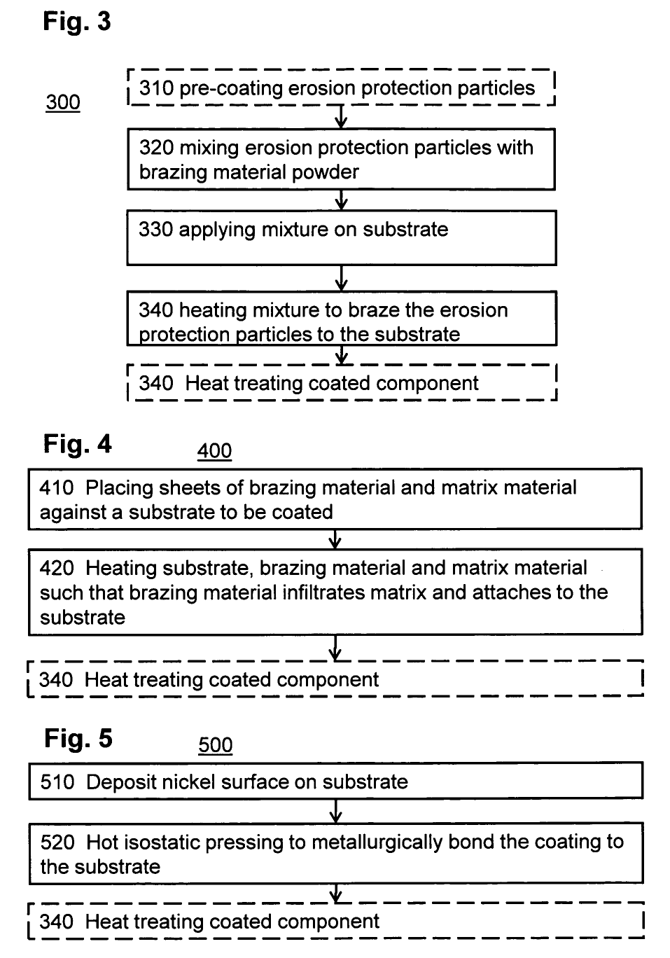

FIGS. 3 and 4 illustrate various surface brazing-based processes for producing the coating 110.

FIG. 3 illustrates a process according to an embodiment of the invention for manufacturing a component adapted to an environment exposed to chlorine, which component comprises a substrate and a coating on the substrate configured to shield the substrate from erosion and corrosion. In this process, a coating is formed by surface brazing from a protective material that has at least two components; one component that melts, metallurgically bonds the coating to the substrate and densifies the coating during the surface brazing process, and another that remains as substantially solid particles during the surface brazing process. The process comprises an optional preparatory step of pre-coating 310 erosion protection particles with a material that has a chemical composition suitable for being wetted by the braze material when the coating is being surface brazed. The pre-coating of the erosion protection particles may use an electrolytic process, a chemical process, mechanical depositing, physical vapor deposition process, chemical vapor deposition process, nickel vapor deposition process, or any combination thereof.

The erosion protection particles, whether pre-coated or not, are then mixed 320 into a mixture in the process shown in FIG. 3 with brazing material powder. The mixture is then applied 330 onto the substrate to be protected. Next, the substrate and the mixture are heated to surface braze the erosion protection particles together and to the substrate. Thus coated substrate may then be heat treated in order to enhance the component's mechanical properties such as elongation at failure, ductility, and/or tensile strength.

The applying of the mixture in step 330 may be carried out by forming a preform out of the mixture onto the substrate. Further alternatively, the mixture may be sprayed onto the substrate. Yet further alternatively, a slurry may be formed of the mixture and applied onto the substrate.

In particular embodiments of the invention, the protective material comprises erosion protection particles selected from a group consisting of: ceramic material such as Al₂O₃, SiO₂, ZrO₂, Cr₂O₃, partially stabilized zirconia (PSZ), mixed oxides, metallic materials such as Ni, Co, Cu, Ag, W, Mo, Fe, Cr or their alloys; and substantially inert carbides such as TiC.

Depending on embodiment, the erosion protection particles comprises different amounts of carbon or carbides. In some embodiments, the erosion protection particles contains less than 5 weight % carbon, less than 2 weight % carbon, less than 0.2 weight % carbon, or be no substantial amount of carbides at all (substantially 0 weight %).

The brazing material may be substantially inert. In an embodiment, the brazing material comprises Ni based brazing alloy such as BNi-1, BNi-1a, BNi-2, BNi-3, BNi-4, BNi-5, BNi-6, BNi-7; and Cu based brazing materials. Exemplary specifications for materials BNi-x (where x stands for an integer 1 to 7 or to 1a) can be found in American Welding Society standards (Specification for Filler Metals for Brazing and Braze Welding). It is appreciated that minor deviations may be made in the composition of the materials without departing from the scope of the invention.

Generally, the coating of the protective material is produced in order to form a dense layer that prevents or substantially mitigates entry of corrosive species through the dense layer.

The component may be a replaceable erosion shield. Alternatively, the component may form or belong to be at least a part of one of the following: tubes and attachments; air pre-heaters; economizers; boiler bank; furnace; super heaters; combustion air nozzles; and smelt spouts.

FIG. 4 demonstrates a surface brazing process in which infiltration is used. In infiltration, the brazing material and erosion protection particles are not (substantially) mixed first, but instead the substrate is first covered 410 by sheets of erosion protection particles that comprise the erosion protection particles and of brazing material. The substrate, the sheets of erosion protection particles and the brazing material are then heated so that the brazing material infiltrates into a matrix of erosion protection particles and surface brazes the erosion protection particles to the substrate. The coated component may be heat treated.

FIG. 5 shows a process 500 for protecting a component against corrosion and/or erosion under presence of corrosive species and high temperature according to a yet further embodiment of the invention. In this process, the substrate is coated by substantially pure nickel in a deposition process 510 such as nickel vapor deposition. The coating is then metallurgically bonded or attached to the substrate by hot isostatic pressing

Some embodiments of the invention are particularly useful in power plants. It is appreciated that the efficiency of electricity production in power plants is determined by the temperature of superheated steam. In modern power plants combusting coal, this temperature is 550-580° C. In power plants combusting chlorine-containing fuels, for example biofuels or waste, this temperature is often limited below 500° C. in order to keep the corrosion rate of the components in economically acceptable level. Increasing the corrosion resistance of boiler components enables increasing the life-time of the boiler components with current steam temperature, and/or elevating steam temperature so as to increase the efficiency of the electricity production.

According to an embodiment of the invention, a mild steel tube component is being protected i.e. the wall of the tube is the substrate to protect. In this example, the protection is provided against corrosion and erosion. The tube is coated with a mixture that comprises 50 weight % sintered and crushed Al₂O₃ particles with particle size of 10-50 μm. The Al₂O₃ particles are pre-coated with 1 μm Ni e.g. by using chemical vapour coating (CVD). A mixture powder is prepared of pre-coated Al₂O₃ powder and of equal amount (50 weight %) of BNi-2 in particles smaller than 53 μm. The mixture is mixed with polyvinyl alcohol into a slurry that is then applied on the substrate with thickness of 0.5 mm. Then, surface brazing is performed in a hydrogen atmosphere at 1050° C.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

We claim:

1. A component adapted to an environment exposed to corrosive species, the component comprising:
a substrate; and
a coating on the substrate configured to shield the substrate from at least one of erosion and corrosion; wherein
the coating is formed by nickel vapor deposition; and
the coating is configured to form a dense layer consisting of a protective material that substantially reduces corrosion rate under presence of the corrosive species.

2. A component according to claim 1, wherein the coating is further hot isostatic pressing processed.

3. A component according to claim 1, wherein the component is a replaceable shield for a steam boiler, the replaceable shield being configured to protect against at least one of erosion and corrosion.

4. A component adapted to an environment exposed to corrosive species, the component comprising:
a substrate; and
a coating on the substrate configured to shield the substrate from at least one of erosion and corrosion; wherein
the coating is metallurgically bonded to the substrate; and
the coating is surface brazed onto the substrate so as to form a dense layer against corroding of the substrate by the corrosive species.

5. A component according to claim 4, wherein the coating is surface brazed onto the substrate by using infiltration.

6. A component according to claim 4, wherein the protective material is formed by surface brazing erosion protection particles to the substrate.

7. A component according to claim 6, wherein the erosion protection particles are coated so as to improve wetting in surface brazing process.

8. A component according to claim 6, wherein the protective material comprises brazing material that is alloyed to have a melting temperature that is substantially lower than the melting temperature of the erosion protection particles.

9. A component according to claim 4, wherein the brazing material comprises Ni-based brazing alloys including BNi-1, BNi-1a, BNi-2, BNi-3, BNi-4, BNi-5, BNi-6, BNi-7 according to American Welding Society standards; and Cu based brazing materials.

10. A component according to claim 4, wherein the surface brazing is performed in a temperature range of 950 to 1150 degrees of Celsius.

11. A component according to claim 6, wherein the erosion protection particles are formed of a material selected from a group consisting of: ceramic material such as Al₂O₃, SiO₂, ZrO₂, Cr₂O₃, partially stabilized zirconia (PSZ), mixed oxides, metallic materials such as Ni, Co, Cu, Ag, W, Mo, Fe, Cr or their alloys; and substantially inert carbides such as TiC.

12. A component according to claim 11, wherein the erosion protection particles comprise less than 1% carbides.

13. A component according to claim 4, wherein the component is adapted to use in material temperature of 400° C. to 600° C. in presence of the corrosive species.

14. A component according to claim 4, wherein the corrosive species comprises chlorine or chlorine compounds.

15. A component according to claim 4, wherein the protective material is substantially inert in the presence of oxygen and chlorine or chlorine compounds.

16. A component according to claim 4, wherein the protective material and the substrate may have substantially similar thermal expansion coefficients.

17. A component according to claim 4, wherein the component is a replaceable shield for a steam boiler, the replaceable shield being configured to protect against at least one of erosion and corrosion.

18. A component according to claim 4, wherein the component is a steam boiler component and forms or belongs to at least a part of one of the following: tubes and attachments; air pre-heaters; economizers; boiler bank; furnace; super heaters; combustion air nozzles; and smelt spouts.

19. A method for manufacturing a component adapted to an environment exposed to corrosive species, the component comprising:
a substrate; and
a coating on the substrate configured to shield the substrate from erosion and corrosion;
the method comprising:
metallurgically bonding the coating to the substrate by surface brazing; and
forming by the coating a dense layer so as to form dense layer against corroding of the substrate by the corrosive species.

20. A method according to claim 19, wherein the protective material is formed by surface brazing erosion protection particles to the substrate.

21. A method according to claim 20, wherein the erosion protection particles are coated so as to improve wetting in surface brazing process.

22. A method according to claim 21, wherein the coating of the erosion protection particles is performed using an electrolytic process, a chemical process, mechanical depositing, physical vapor deposition process, chemical vapor deposition process, nickel vapor deposition process, and any combination thereof.

23. A method according to claim 19, wherein the protective material is formed in a process comprising:
applying mixture of brazing material and erosion protection particles on the substrate; and
heating the substrate and the mixture such that the brazing material surface brazes the erosion protection particles to the substrate.

24. A method according to claim 20, wherein the erosion protection particles comprise less than 1% of carbides.

25. A method according to claim 23, further comprising forming a slurry comprising the mixture, wherein the applying of the mixture on the substrate comprises applying the slurry onto the substrate.

26. A method according to claim 19, wherein the component is heat treated after the surface brazing.
